(19) United States
(12) Patent Application Publication
(10) Pub. No.: US 2011/0102142 A1
(43) Pub. Date: May 5, 2011

(54) WEBCAST VIEWER VERIFICATION METHODS

(76) Inventors: IAN J. WIDGER, Clackamas, OR (US); Steven J. Silves, Ridgefield, WA (US); Jeremy M. Knight, Lake Oswego, OR (US)

(21) Appl. No.: 12/612,628

(22) Filed: Nov. 4, 2009

(51) Int. Cl. G06F 7/04; H04N 7/18; G06K 9/00; G10L 17/00; G06F 3/033; G06F 3/048; G06F 15/16

(52) U.S. Cl. 340/5.83; 348/143; 382/118; 704/246; 345/163; 715/730; 348/E07.085; 704/E17.001; 709/203

(57) ABSTRACT

A system and associated method verify the attendance and/or identity of viewers of audio/video/data streams transmitted over the internet. The system and method captures various types of interaction with the viewers and either takes appropriate action, as configured by a webcast program administrator, or simply logs this interaction to a database where audience attention and identity can be validated at a later date.

### CROSS REFERENCE TO RELATED APPLICATION(S)

This application is not related to any other issued patents or patent applications.

### TECHNICAL FIELD

This disclosure relates to systems and services for conducting telecommunications over the internet.

### BACKGROUND

The coordinated transmission over the internet of either ‘live’ or ‘archived’ (recorded) information in a variety of media formats such as audio/video, personal computer screen capture, streamed audio and slide presentations, for example, from a few sources to a multitude of viewers, is commonly collectively referred to as “webcasting”. A specific instance of ‘webcasting’ being referred to as a ‘webcast’.

As an example a typical application using Internet webcasting is ‘distance-learning’. Among the many compelling advantages related to the use of webcasting for distance-learning are the overwhelming cost advantages, the ability to cost-effectively tailor content to more specifically targeted audiences, the huge reduction in logistical burdens on audience members through the avoidance of travel and accommodation related activities required with alternative teaching methods where physical presence is required.

Typical entities benefitting from the use of webcasting for distance learning would include universities and educational institutions, corporations for internal and external training and promotional activities and professional bodies for the continuous education often mandated by their professional standards.

Webcasting methods are now quite advanced and can achieve excellent results in cases where the viewer (student) is a strong contributor to the process. That is to say where the recipient is present and attentive. This is no different from the more traditional, physical, classroom learning environment. If a student is frequently absent or has their attention distracted from the teaching process then the class is going to be far less effective for them and any attendance-related graduation credit they may achieve will be of less value to any interested third party (i.e. employer or professional standards body).

A major challenge with the use of webcasting to implement distance learning programs is the inability to verify whether the recipient persons (viewers) receiving the class remotely are present at the time of the class, are paying attention to the presented material during the class, and are indeed who they claim to be.

Many professional organizations, for example legal and medical, mandate a continuing education requirement for their members to meet minimum practitioner standards. Such continuing education is frequently conducted using webcasting methods over the internet. These organizations face similar challenges in verifying their members' compliance with their mandated continuous education minimums.

Most companies of more than, say, 10 employees, for example, would find the use of archived webcasting a great advantage in improving the efficiency of various information dispersal requirements. Such requirements might include new employee induction training, company policy refreshment, product and strategy re-education, etc. Similarly the challenge faced by these companies when considering the webcasting approach is how to verify that the employee did indeed take the required courses and did indeed pay attention during the sessions.

### BRIEF DESCRIPTION OF THE DRAWINGS

FIG. 1 is a network diagram that illustrates an example of a webcasting platform under one embodiment of the inventive system.

FIG. 2 illustrates the attendance verification method by which a viewer is prompted to enter a randomly generated number at a specific position on the screen of their viewing device.

FIG. 3 illustrates the attendance verification method by which a viewer is prompted to use an input device, such as a computer mouse, to indicate their attendance by “clicking” on an indicated position on the screen of their viewing device. In a similar implementation the viewer may be asked to enter text or to click on a multiple choice indicator to verify their attention

FIG. 4 illustrates the attendance and identity verification method by which a viewer verification application controls a camera at the viewer location to capture still images or record video files of a viewer. In one embodiment such images may be processed using facial recognition software.

FIG. 5 illustrates the attendance verification method by which the voice of a viewer is recorded and used to verify their attendance and identity. In one embodiment such recorded voice samples may be processed using voice signature or speaker recognition software.

FIG. 6 illustrates the attendance and identity verification method by which a viewer verification application controls a biometric capture device at the viewer location to verify the viewer attendance and identity.

FIG. 7 illustrates the attendance and identity verification method by which a viewer verification application challenges a viewer to authenticate themselves via any of the methods described and pauses the delivery of content while waiting for positive verification to be completed.

### DETAILED DESCRIPTION OF THE ILLUSTRATED EMBODIMENTS

A method and apparatus for verifying the identity and presence of attendees to a live or archived ‘webcast’ is described in detail herein. A ‘webcast’ in this context may be defined as an event where one or more organizers and/or presenters orchestrate the delivery of multimedia content to one or more audience members via the internet and/or related telecommunications networks. In the following description, numerous specific details are provided, such as specific steps, ordering of steps, types of networks and networking equipment, and the like, to provide a thorough understanding of, and enabling description for, embodiments of the invention. One skilled in the relevant art, however, will recognize that the invention can be practiced without one or more of the specific details, or with other steps, ordering of steps, networks, equipment and the like. In some other instances, well known structures or operations are not shown, or not described in detail, to avoid obscuring aspects of the invention.

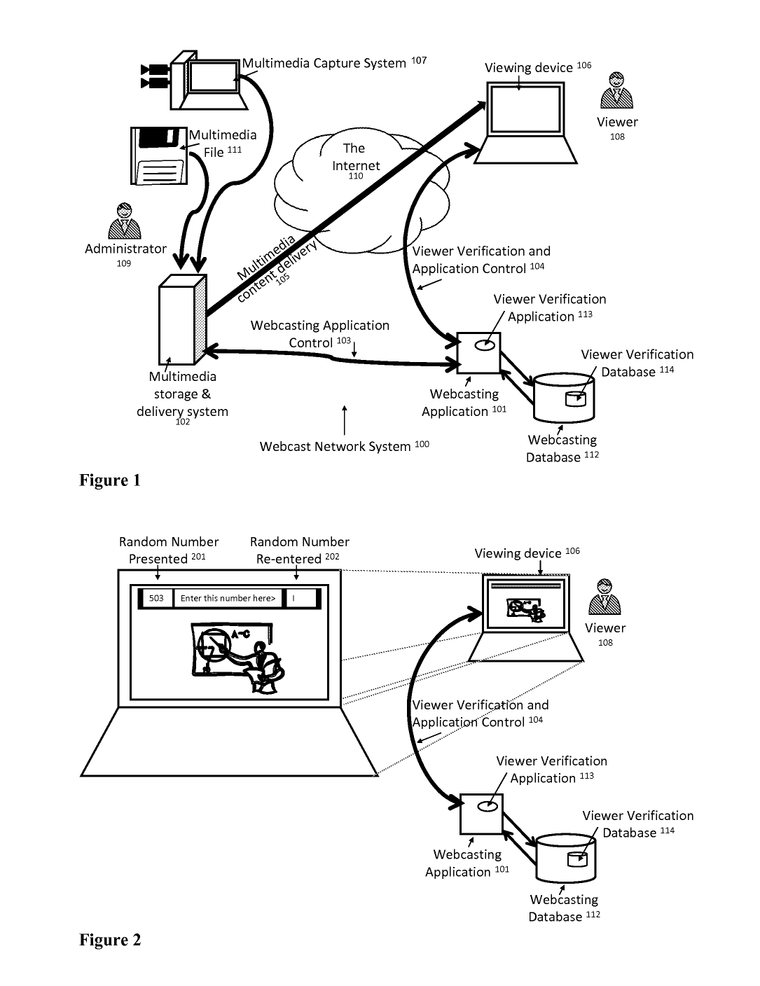

Referring to FIG. 1, an example of a system 100 under one aspect of the invention employs a media capture server 107 to capture, encode and transmit information from a live event to a media storage and delivery system 102. The media capture server 107 has a variety of information capture capabilities such as cameras, microphones, document readers and screen capture devices some of which are activated during the live event. An example of a typical live event that may be captured in this way would be a university lecture for example. However any live event may be captured in this way.

The media storage and delivery system 102 may be used to deliver captured content to viewer devices 106 synchronously with the captured event where the viewer device 106 renders the content only a few tens of seconds after the actual event occurs. This is referred to as live real-time streaming of the captured content by the media storage and delivery system 102.

The media storage and delivery system 102 may be used to deliver captured content to viewer devices 106 at some unspecified time, for example days, weeks, months or even years, after the captured event has occurred. This is referred to as content archival and on-demand streaming of the captured content by the media storage and delivery system 102.

As an alternative content acquisition method, archived content in the form of a media file 111 may be uploaded to the media storage and delivery system 102 using a standard file transfer method.

Viewing of the media content available at the media storage and delivery system 102 is initiated by a viewing device 106 transmitting viewer registration information to the webcasting application 101. The webcasting application 101 collects registration and other information from the viewer device and then instructs the media storage and delivery system 102 to stream the relevant content to the viewer device 106 over the internet 110 using a suitable connection 105.

The viewer device 106 may be any device with characteristics suitable to display the media content provided by the media storage and delivery system 102 and interact with the webcasting application 101. Typically a viewer device 106 may be a personal computer or mobile hand-held computing device such as an iPhone. More information on the iPhone can be found at http://www.apple.com/iphone/.

The viewer verification application 113 maintains an interactive connection 104 with the viewer device 106 during the viewing session in order to implement the various viewer verification methods that are the subject matter of this disclosure. The viewer verification application 113 uses the associated viewer verification database 114 to store data critical to the viewer verification process as described later and also to store the results of the viewer verification application 113 activity for the specific session or series of sessions to allow a session administrator 109 to retrieve and post-process collected viewer validation statistics.

FIG. 2 illustrates one method of verifying the attendance of a viewer 108. The webcasting application 101 maintains a record within the webcasting database 112 of all registered viewers of a particular webcast session. For each viewing device 106 the viewer verification application 113, at regular or random intervals, generates a unique random number 201 that it displays within a window on the viewing device 106.

Upon displaying the unique random number on the viewer device 106 the viewer verification application 113 starts a timer while it waits for the viewer 108 to read the displayed random number and reenter that number on the keyboard or equivalent digit input of their viewing device 106. Should the viewer 108 fail to enter the random number at the viewing device 106 within the timer period the viewer verification application 113 will register the failure within its viewer verification database 114.

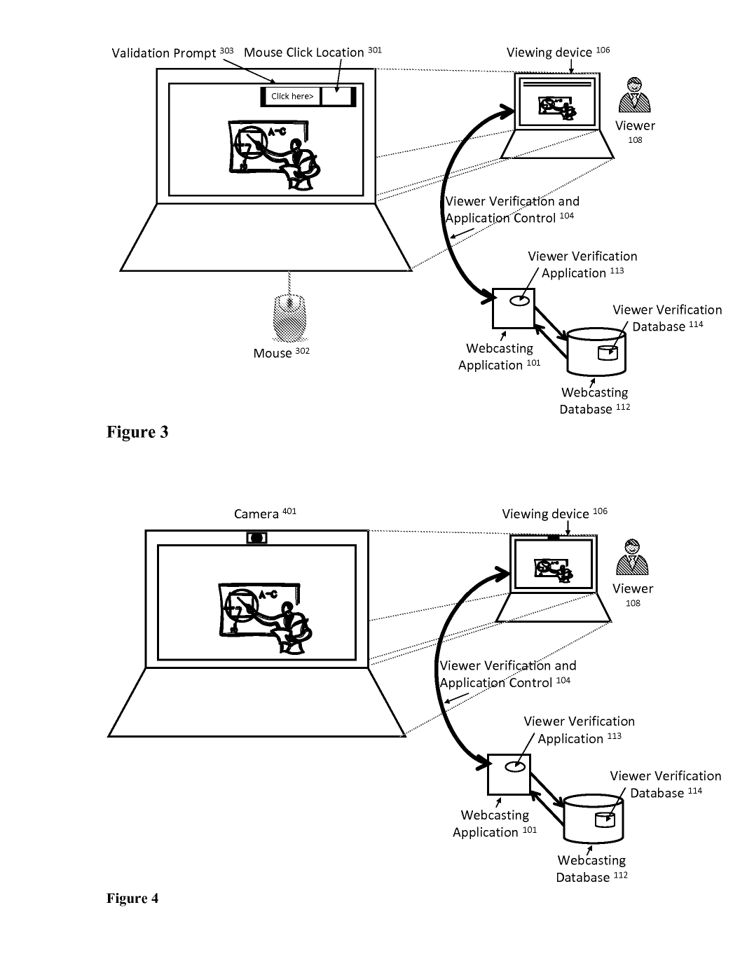

FIG. 3 illustrates an alternative embodiment of the inventive system wherein the viewer verification application 113, at regular or random intervals, displays a prompt on the viewing device 106 requesting the viewer 108 to acknowledge their attendance by clicking on the mouse click location 301 on the viewing device 106. The mouse click location 301 may appear at random positions on the screen to improve the security of this viewer attention verification method. If the viewer 108 clicks the mouse click location 301 in a given time period the viewer verification application 113 marks an entry in the viewer verification database 114 to indicate that the viewer 108 was present and paying attention at the time of their response. Should the viewer 108 fail to click on the indicated space within a configurable timer the viewer verification application 113 will register such failure in its viewer verification database 114.

In an alternative embodiment of the method illustrated in FIG. 3 the viewer verification application 113, at regular or random intervals, displays a prompt on the viewing device 106 requesting the viewer 108 to acknowledge their attendance by selecting from a number of answers to a specific question displayed on the viewing device 106. A typical question might be, for example: “On which side of the screen was the presenter standing in the last section of this webcast”. The viewer 108 would select from multiple choice answers to answer the question. If the viewer 108 clicks the correct response in a given time period the viewer verification application 113 marks an entry in the viewer verification database 114 to indicate that the viewer 108 was present and paying attention at the time of their response. Should the viewer 108 fail to click, or click on the wrong answer, within a configurable timer the viewer verification application 113 will register such failure in its viewer verification database 114.

The webcasting application 101 may take a variety of actions depending on the outcome of the viewer verification application 113 interaction with the viewing device 106 and the viewer 108. In all cases however the activity is logged to the viewer verification database 114. In cases where there is a negative result the webcast application 101 may continue the session, pause the session or terminate the session at the viewing device 106.

The viewer verification methods of FIGS. 2 and 3 allow an administrator of a webcast session to verify the attention of any specific viewer of any, so instrumented, webcast session.

Attention verification alone may not be sufficient for some distance learning applications. It may be required in addition that the identity of a viewer be verified.

FIG. 4 illustrates a method of verifying not only the attention but also the identity of a viewer within the same webcast network system 101 illustrated in FIG. 1. In FIG. 4 the viewing device 106 is equipped with a camera 401 that is controllable by the viewer verification application 113. This camera 401 may be embedded in the device as shown in FIG. 4 or could be a separate camera connected via a suitable interface, for example a universal serial bus (or USB) interface. The viewer verification application 113 at intervals, either random or regular, during the webcast session, causes the camera 401 to take an image of the viewer and stores it in the viewer verification database 114 with a set of related information such as the date and time the image was taken, details of the specific webcast session being viewed, details of the viewer and the elapsed time of the session at which the image was captured. The resulting sequence of images captured during the webcast session may be scrutinized after the fact by the administrators of the webcast program in order to verify the attendance of any specific viewer 108.

As illustrated in FIG. 4, the attendance verification method based on the random or regular capture of photographic images of the viewer 108 synchronized with the webcast session may be enhanced by increasing the image capture frequency to the point where the sequence becomes a full motion video record of the viewer 108. Such a video record may be compressed in various ways familiar to anyone versed in the relevant art in order to limit the amount of physical storage required for viewer verification.

As illustrated in FIG. 4, the attendance verification method based on the random or regular capture of photographic images of the viewer 108 synchronized with the webcast session may be enhanced by the addition of facial recognition software. More about facial recognition software may be found at http://www.sensiblevision.com/. Through the use of facial recognition software the viewer verification application 113 would be able to automatically assess attendance and identity of the viewer 108 by comparison with reference images of the viewer 108 captured under controlled conditions and stored in the viewer verification database 114. This replaces the need for a human operator, such as the webcast session administrator 109, to view the captured images in order for an assessment of the attendance and identity of a viewer 108 to be made. Rather the viewer verification application 113 would automatically rate the attendance and identity of all viewers 108 and human operators or webcast session administrators 109 would be able to selectively view the photographic record of only those sessions marked by the viewer verification application 113 as having questionable attendance or identity ratings.

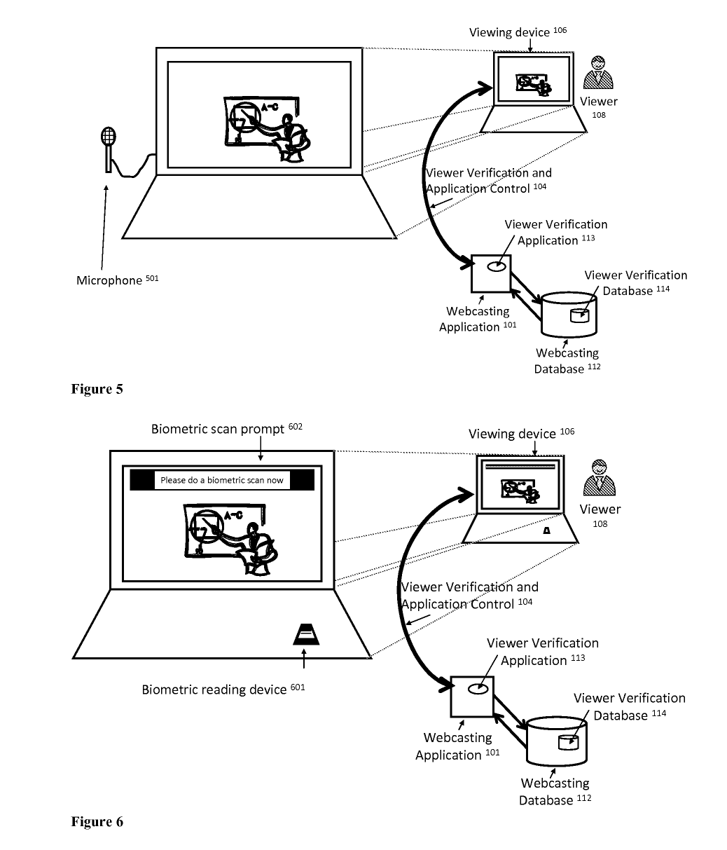

FIG. 5 illustrates a method of verifying not only the attention but also the identity of a viewer 108 using speaker recognition (otherwise known as voice signature) techniques. A reference voice sample recording, or set of such samples, are captured under controlled conditions and stored in the viewer verification database 114. This capture of reference samples of the speech of the viewer 108 would best be made using the same environment including the viewing device 106 and attached microphone 501 that is to be used by the viewer 108 to subsequently view the webcast material. The audio energy of the reference samples is processed by the viewer verification application 113 and a set of parameters representing the attendee's voice signature are captured and stored in the viewer verification database 114. Such parameters may be biometric in nature representing the unique properties of the speaker's vocal tract; alternatively they may be behavioral representing pitch and inflection of the speech. The specific methods of deriving a unique set of parameters from spoken audio energy to form a voice signature is not the subject of this disclosure and is well understood by those versed in the relevant art. In principle the speech characteristics of an individual manifest themselves in specific patterns within the spoken audio energy generated by that individual. These patterns can be digitized and then processed by appropriate software to produce a set of values characteristic of the individual speaking. Trade harbor is a company offering such voice signature and speaker recognition software, more about their capability may be found at http://www.tradeharbor.com/.

At the start of a distance learning session the viewer 108 is prompted to speak specific words or a short section of text by the viewer verification application 113. The audio energy generated by the attached microphone 501 as a result of the prompted speech is processed by the speaker recognition software within the viewer verification application 113 to verify the identity of the viewer 108 and to re-calibrate the speaker recognition mechanism for the specific session. The viewer verification application 113 produces a likelihood value that the viewer 108 is indeed the same individual who registered for the current session and to whom credits for attending would be due. The webcast program administrator 109 configures a threshold for the likelihood value such that further action related to a failure to verify a viewer 108 identity would be triggered automatically by the viewer verification application 113. By selecting an appropriate likelihood threshold value the administrators 109 could modify the respective security of different programs and sessions. The higher the likelihood threshold the greater the number of falsely generated warnings of unauthorized access would be generated but the greater the level of verification would be imposed.

In one embodiment of the invention, during the session as illustrated in FIG. 5 the continued attention of the verified viewer 108 is randomly checked by the viewer verification application 113 by generating further prompts for a spoken reaction by the viewer 108 and rerunning the speaker recognition process. Such continued verification may be imposed at a different, and potentially lower, level of inconvenience to the viewer 108 than that implemented at the start of a session. For example the initial verification may require 10 or 20 words to be read to achieve the required level of verification while random checks during the session may be reduced to just one word to achieve an appropriate verification result.

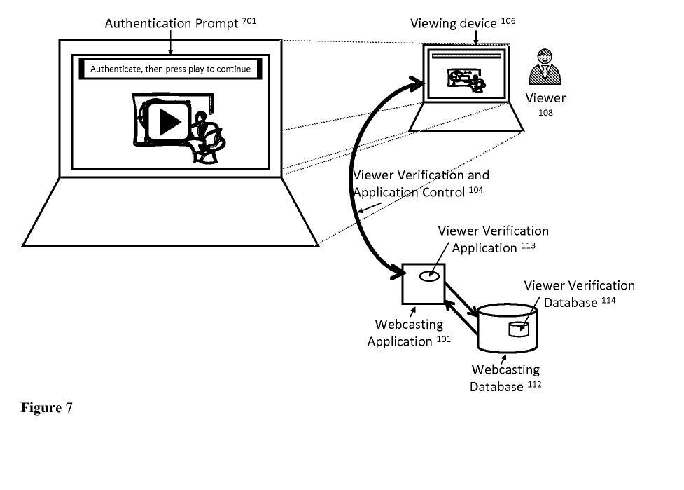

FIG. 6 illustrates a method of verifying not only the attention but also the identity of a viewer 108 using biometric scanning techniques. A reference biometric scan is captured under controlled conditions and stored in the viewer verification database 114. This capture of a reference biometric scan of the viewer 108 would best be made using the same environment including the viewing device 106 and attached biometric reading device 601 that is to be used by the viewer 108 to subsequently view the webcast material. The specific methods of capturing and storing a biometric scan to be later used to identify an individual are not the subject of this disclosure and are well understood by those versed in the relevant art. Typical biometric scanning techniques include the reading of finger-print patterns and the scanning of retina and/or cornea patterns. Further information on biometric security techniques can be found at http://en.wikipedia.org/wiki/Biometrics. Digital Persona, Inc. is a company offering such biometric security capabilities, more about their capability may be found at www.digitalpersona.com.

At the start of a webcast session the viewer 108 is prompted to provide a biometric scan to validate their identity by the viewer verification application 113. This may, for example, be a fingerprint scan and in that case would require that the viewer 108 press their finger tip onto a biometric reading device 601 designed for the purpose of reading, digitizing and transmitting the fingerprint properties to the viewer verification application 113. The digital scan generated by the attached biometric reading device 601 is processed by the biometric analysis software within the viewer verification application 113 to verify the viewer 108. The viewer verification application 113 detects whether the viewer 108 is indeed the same individual who registered for the current session and to whom credits for attending would be due.

In one embodiment of the invention, during the session as illustrated in FIG. 6 the continued attention of the verified viewer 108 is randomly checked by the viewer verification application 113 by generating further prompts for biometric verification by the viewer 108.

FIG. 7 illustrates a method of verifying the attention of a viewer 108 by requiring viewer verification, using any one of the above mentioned techniques, at the end of one section, or chapter, of the webcast before the webcasting application 101 will proceed to transmit the next section to the viewer 108.

The illustrated attendance verification systems using video, still image, voice, random number, biometrics and simple input device stimulus approaches as described above may be combined in any permutation to achieve a specific level of verification.

The illustrated attendance verification systems using video, still image, voice, random number, biometrics and simple input device stimulus approaches as described above may be combined in any permutation to achieve a specific level of verification.

These attention validation methods can be modified slightly to address the common case where viewers congregate together in meeting rooms or auditoria.

In one embodiment where there are multiple viewers in a group setting the viewer verification application displays, at regular or random intervals during the session, random numbers as illustrated in FIG. 2. Viewers record the displayed numbers. The viewers are able to verify their attendance after the session by presenting the list of random numbers displayed and recorded during the session.

In another embodiment where there are multiple viewers in a group setting the viewer verification application uses a camera located with the viewing device, as illustrated in FIG. 4 to capture still or moving pictures (video) of the audience. The attendance of individual viewers in the audience can be verified later by inspection of the recorded images or moving pictures (video).

In another embodiment where there are multiple viewers in a group setting the viewer verification application interacts with a viewer verification client application resident on an internet connected computing device controlled by each viewer in the audience. Such an internet connected computing device might be a mobile phone or PDA. In this embodiment the viewer verification application may challenge the viewer with questions, may simply require acknowledgement in the form of a simple input device interaction (mouse click) or may require the entry of displayed random numbers as illustrated in FIGS. 2 and 3.

We claim:

1. A computer-implemented method for verifying the attention of viewers attending video and audio presentations delivered remotely over a wide-area telecommunications network such as the internet, collectively referred to as ‘webcasts’, wherein a viewer is an individual person, the method comprising:
an attendance verification software application that interacts with the viewer by remotely controlling the viewing device, wherein the attendance verification software application, at random or regular intervals during an audio/video presentation session, prompts the user to react using a computer mouse or similar input device;
an attendance verification database wherein the interaction with the viewer is logged, as well as the time and date, the session identifiers and the elapsed time of the session.

2. The method of claim 1 wherein the webcasting application is programmed to respond to a failure of the viewer to respond to a prompt from the attendance verification software by pausing the in-progress session for a configurable timer period. If the viewer's correct response is detected before the configurable timer expires the session is resumed either at the point when it was paused or at some time prior to the point at which it was paused. If the viewer's correct response is not detected within the configurable timer period the session is terminated. The attendance verification interaction activity is logged in the attendance verification database to allow reporting to be generated for the session administrator and to trigger future interaction with the viewer, either automatic or manual, to allow the viewer to take necessary steps to receive the session information at a later date.

3. The method of claim 1 wherein the webcasting application is programmed to respond to a failure of the viewer to respond to a prompt from the attendance verification software by terminating the session. The attendance verification interaction activity is logged in the attendance verification database to allow reporting to be generated for the session administrator and to trigger future interaction with the viewer, either automatic or manual, to allow the viewer to take necessary steps to receive the session information at a later date.

4. The method of claim 1 wherein the webcasting application is not programmed to respond to a failure of the viewer to respond to a prompt from the attendance verification software. The attendance verification interaction activity is logged in the attendance verification database to allow reporting to be generated for the session administrator and to trigger future interaction with the viewer, either automatic or manual, to allow the viewer to take necessary steps to receive the session information at a later date.

5. A computer-implemented method for verifying the attention of viewers attending video and audio presentations delivered remotely over a wide-area telecommunications network such as the internet, collectively referred to as ‘webcasts’, wherein a viewer is an individual person, the method comprising:
an attendance verification software application that interacts with the viewer by remotely controlling the viewing device, wherein the attendance verification software application, at random or regular intervals during an audio/video presentation session, challenges the user to answer a question, or set of questions, concerning the previous segment of the session.
an attendance verification database wherein the attendance verification interaction with the viewer is logged, as well as the time and date, the session identifiers and the elapsed time of the session.

6. The method of claim 5 wherein the webcasting application is programmed to respond to a failure of the viewer to correctly answer a question presented by the attendance verification software by pausing the in-progress session for a configurable timer period. If the viewer's correct response is detected before the configurable timer expires the session is resumed either at the point when it was paused or at some time prior to the point at which it was paused. If the viewer's correct response is not detected within the configurable timer period the session is terminated. The attendance verification interaction activity is logged in the attendance verification database to allow reporting to be generated for the session administrator and to trigger future interaction with the viewer, either automatic or manual, to allow the viewer to take necessary steps to receive the session information at a later date.

7. The method of claim 5 wherein the webcasting application is programmed to respond to a failure of the viewer to correctly answer a question presented by the attendance verification software by terminating the session. The attendance verification interaction activity is logged in the attendance verification database to allow reporting to be generated for the session administrator and to trigger future interaction with the viewer, either automatic or manual, to allow the viewer to take necessary steps to receive the session information at a later date.

8. The method of claim 5 wherein the webcasting application is not programmed to respond to a failure of the viewer to correctly answer a question presented by the attendance verification software. The attendance verification interaction activity is logged in the attendance verification database to allow reporting to be generated for the session administrator and to trigger future interaction with the viewer, either automatic or manual, to allow the viewer to take necessary steps to receive the session information at a later date.

9. A computer-implemented method for verifying the attention of viewers attending video and audio presentations delivered remotely over a wide-area telecommunications network such as the internet, wherein a viewer is an individual person, the method comprising:
an attendance verification software application that interacts with the viewer by remotely controlling the viewing device, wherein the attendance verification software application, at random or regular intervals during an audio/video presentation session, presents the viewer with randomly generated number, unique to that viewer, and requests the viewer to enter the presented number into a specific field on the screen of the viewing device;
an attendance verification database wherein the interaction with the viewer is logged, as well as the time and date, the session identifiers and the elapsed time of the session.

10. The method of claim 9 wherein the webcasting application is programmed to respond to a failure of the viewer to correctly enter the random number generated by the attendance verification software by pausing the in-progress session for a configurable timer period. If the viewer's correct response is detected before the configurable timer expires the session is resumed either at the point when it was paused or at some time prior to the point at which it was paused. If the viewer's correct response is not detected within the configurable timer period the session is terminated. The attendance verification interaction activity is logged in the attendance verification database to allow reporting to be generated for the session administrator and to trigger future interaction with the viewer, either automatic or manual, to allow the viewer to take necessary steps to receive the session information at a later date.

11. The method of claim 9 wherein the webcasting application is programmed to respond to a failure of the viewer to correctly enter the random number generated by the attendance verification software within a time period only long enough to allow immediate reaction from the viewer by terminating the session. The attendance verification interaction activity is logged in the attendance verification database to allow reporting to be generated for the session administrator and to trigger future interaction with the viewer, either automatic or manual, to allow the viewer to take necessary steps to receive the session information at a later date.

12. The method of claim 9 wherein the webcasting application is not programmed to respond to a failure of the viewer to correctly enter the random number generated by the attendance verification software. The attendance verification interaction activity is logged in the attendance verification database to allow reporting to be generated for the session administrator and to trigger future interaction with the viewer, either automatic or manual, to allow the viewer to take necessary steps to receive the session information at a later date.

13. A computer-implemented method for verifying the attention and identity of viewers attending video and audio presentations delivered remotely over a wide-area telecommunications network such as the internet, wherein a viewer is an individual person, the method comprising:
an attendance verification software application that captures, at random or regular intervals during an audio/video presentation session, still images of the viewer by remotely controlling a camera device located with the viewing device;
an attendance verification database wherein the still images of the viewer are logged, as well as the time and date, the session identifiers, the elapsed time of the session.

14. The method of claim 13 wherein facial recognition software is used to assess the identity of the viewer by comparing each image captured during the session with a certified image of the viewer held for the identity verification purpose. The result of the facial recognition software assessment is logged in the attendance verification database with the captured images of the viewer, the time and date, the session identifiers, the elapsed time of the session.

15. The method of claim 14 wherein the attendance verification software is programmed to respond to a facial recognition assessment of the probability of a positive match between the viewer and the identification image below a configurable confidence threshold by repeating the image capture and facial recognition cycle a configurable number of times. If the positive facial recognition probability confidence threshold is not exceeded during this reactive sequence of attempts the webcasting application will terminate the session. The attendance verification interaction activity is logged in the attendance verification database to allow reporting to be generated for the session administrator and to trigger future interaction with the viewer, either automatic or manual, to allow the viewer to take necessary steps to receive the session information at a later date.

16. The method of claim 14 wherein neither the attendance verification software nor the webcasting application are programmed to take any action dependent on the outcome of the activity of the facial recognition software. The attendance verification interaction activity, including the facial recognition software output and the still images, are logged in the attendance verification database to allow reporting to be generated for the session administrator and to trigger future interaction with the viewer, either automatic or manual, to allow the viewer to take necessary steps to receive the session information at a later date.

17. A computer-implemented method for verifying the attention and identity of viewers attending video and audio presentations delivered remotely over a wide-area telecommunications network such as the internet, wherein a viewer is an individual person, the method comprising:
an attendance verification software application that continuously captures, during an audio/video presentation session, real-time video of the viewer by remotely controlling a camera device located with the viewing device;
an attendance verification database wherein the captured video of the viewer is logged, as well as the start and end times and dates and the associated session identifiers.

18. A computer-implemented method for verifying the attention and identity of viewers attending video and audio presentations delivered remotely over a wide-area telecommunications network such as the internet, wherein a viewer is an individual person, the method comprising:
an attendance verification software application that captures at random intervals, or at regular intervals, during an audio/video presentation session, real-time video of the viewer by remotely controlling a camera device located with the viewing device;
an attendance verification database wherein the captured video of the viewer is logged, as well as the start and end times and dates, the associated session identifiers and the elapsed times of the session at the start and end of the video capture periods.

19. The methods of claims 17 and 18 wherein the administrator of the audio/video session can view the captured video in real-time to assess the identity and attention of the viewers.

20. The methods of claims 17 and 18 wherein the administrator of the audio/video session can view the captured video at any time after the completion of a session to assess the identity and attention of the viewer of that session.

21. A computer-implemented method for verifying the attention and identity of viewers attending video and audio presentations delivered remotely over a wide-area telecommunications network such as the internet, wherein a viewer is an individual person, the method comprising:
an attendance verification software application that captures, at random or regular intervals during an audio/video presentation session, voice clips from the viewer by remotely controlling a microphone device located with the viewing device;
an attendance verification database wherein the voice clips of the viewer are logged, as well as the time and date, the session identifiers, the elapsed time of the session.

22. The method of claim 21 wherein voice signature software is used to assess the identity of the viewer by comparing each voice clip captured during the session with a certified voice signature of the viewer held for the identity verification purpose. A certified voice signature is a set of parameters derived from analysis of a reference speech sample known to have been spoken by a specific individual. The result of the voice signature software assessment is logged in the attendance verification database with the recorded voice clips of the viewer, the time and date, the session identifiers, the elapsed time of the session.

23. The method of claim 22 wherein the attendance verification software is programmed to respond to a voice signature assessment of the probability of a positive match between the recorded voice clip of the viewer and the certified voice signature of the viewer below a configurable confidence threshold by repeating the voice clip recording and voice signature assessment a configurable number of times. If the positive voice signature probability confidence threshold is not exceeded during this reactive sequence of attempts the session management software will terminate the session. The attendance verification interaction activity is logged in the attendance verification database to allow reporting to be generated for the session administrator and to trigger future interaction with the viewer, either automatic or manual, to allow the viewer to take necessary steps to receive the session information at a later date.

24. The method of claim 22 wherein neither the attendance verification software nor the webcasting application are programmed to take any action dependent on the outcome of the activity of the voice signature software. The attendance verification interaction activity, including the voice signature software output and the recorded voice clips, are logged in the attendance verification database to allow reporting to be generated for the session administrator and to trigger future interaction with the viewer, either automatic or manual, to allow the viewer to take necessary steps to receive the session information at a later date.

25. A computer-implemented method for verifying the attention and identity of viewers attending video and audio presentations delivered remotely over a wide-area telecommunications network such as the internet wherein a viewer is an individual person, the method comprising:
an attendance verification software application that captures, at random or regular intervals during an audio/video presentation session, biometric readings of the viewer by prompting the viewer to press a fingertip to a fingerprint scanner or look into a retinal or corneal scanner, located with the viewing device, and then receiving the digital output of that biometric reading device;
an attendance verification database wherein the biometric readings of the viewer are stored, as well as the time and date, the session identifiers and the elapsed time of the session at the moment that the biometric reading was taken.

26. The method of claim 25 wherein the captured biometric reading data is processed and compared to a reference biometric reading for the registered individual viewer whose attention and identity requires verification. The result of the biometric reading comparison, identity match ‘true’ or ‘false’, is logged in the attendance verification database with the biometric data and associated data as listed in claim 25.

27. The method of claim 25 wherein the attendance verification software is programmed to respond to a ‘false’ biometric match result by repeating the biometric reading a configurable number of times. If no ‘true’ match result can be achieved during this reactive sequence of biometric identity validation attempts the viewer verification application will instruct the webcasting application to terminate the session. The biometric reading activity is logged in the attendance verification database to allow reporting to be generated for the session administrator and to trigger future interaction with the viewer, either automatic or manual, to allow the viewer to take necessary steps to receive the session information at a later date.

28. The method of claim 25 wherein neither the attendance verification software nor the webcasting application are programmed to take any action dependent on the outcome of the activity of the biometric identity verification. The identity verification interaction activity, including the biometric reading output, are logged in the attendance verification database to allow reporting to be generated for the session administrator and to trigger future interaction with the viewer, either automatic or manual, to allow the viewer to take necessary steps to receive the session information at a later date.

29. A computer-implemented method for verifying the attention of viewers attending video and audio presentations delivered remotely over a wide-area telecommunications network such as the internet, wherein a group of viewers, each an individual person, are sharing a single viewing device, the method comprising:
an attendance verification software application that interacts with the viewers by remotely controlling the viewing device, wherein the attendance verification software application, at random or regular intervals during an audio/video presentation session, presents the viewers with a randomly generated number, unique to that viewing device. In order to later verify their attendance the viewers are required to record each number as it appears. Viewers who complete the session and have paid attention throughout have thereby collected a list of random numbers. This list of random numbers is presented by the individual viewer as required after the event to verify their attendance.

30. A computer-implemented method for verifying the attention of viewers attending video and audio presentations delivered remotely over a wide-area telecommunications network such as the internet, wherein a group of viewers, each an individual person, are sharing a single viewing device, the method comprising:
an attendance verification software application that interacts with the viewer by remotely controlling the viewing device, wherein the attendance verification software application, at random or regular intervals during an audio/video presentation session, challenges viewers to indicate their attention by interacting with viewer verification client application on their mobile device;
an attendance verification database wherein the interaction with the viewer is logged, as well as the time and date, the session identifiers and the elapsed time of the session.

31. A computer-implemented method for verifying the attention of viewers attending video and audio presentations delivered remotely over a wide-area telecommunications network such as the internet, wherein a group of viewers, each an individual person, are sharing a single viewing device, the method comprising:
an attendance verification software application that interacts with the viewer by remotely controlling the viewing device, wherein the attendance verification software application, at random or regular intervals during an audio/video presentation session, presents a randomly generated number, unique to that viewing device, and requests the viewer to enter the presented number into a viewer verification client application on their mobile device;
an attendance verification database wherein the interaction with the viewer is logged, as well as the time and date, the session identifiers and the elapsed time of the session.

32. A computer-implemented method for verifying the attention of viewers attending video and audio presentations delivered remotely over a wide-area telecommunications network such as the internet, wherein a group of viewers, each an individual person, are sharing a single viewing device, the method comprising:
an attendance verification software application that interacts with the viewer by remotely controlling a viewer verification client application on their mobile device, wherein the attendance verification software application, at random or regular intervals during an audio/video presentation session, challenges the user to answer a question, or set of questions, concerning the previous segment of the session.
an attendance verification database wherein the interaction with the viewer is logged, as well as the time and date, the session identifiers and the elapsed time of the session.

33. A computer-implemented method for verifying the attention of viewers attending video and audio presentations delivered remotely over a wide-area telecommunications network such as the internet, wherein a group of viewers, each an individual person, are sharing a single viewing device, the method comprising:
an attendance verification software application that captures, at random or regular intervals during an audio/video presentation session, still images of the collected viewers by remotely controlling a camera device located with the viewing device;
an attendance verification database wherein the interaction with the viewer is logged, as well as the time and date, the session identifiers and the elapsed time of the session.

34. A computer-implemented method for verifying the attention of viewers attending video and audio presentations delivered remotely over a wide-area telecommunications network such as the internet, wherein a group of viewers, each an individual person, are sharing a single viewing device, the method comprising:
an attendance verification software application that continuously captures, during an audio/video presentation session, real-time video of the viewer by remotely controlling a camera device located with the viewing device;
an attendance verification database wherein the interaction with the viewer is logged, as well as the time and date, the session identifiers and the elapsed time of the session.
